(19) United States
(12) Patent Application Publication
(10) Pub. No.: US 2002/0158171 A1
(43) Pub. Date: Oct. 31, 2002

(54) Holding device for an additional part on a robot

(76) Inventor: Stefan Karlinger, Augsburg (DE)

Correspondence Address: McGLEW AND TUTTLE, P.C., SCARBOROUGH STATION, SCARBOROUGH, NY, 10510-0827, US

(21) Appl. No.: 10/134,056

(22) Filed: Apr. 25, 2002

(30) Foreign Application Priority Data
Apr. 28, 2001 (DE) 101 21 030 . 2

(51) Int. Cl. F16L 3/00

(52) U.S. Cl. 248/49

(57) ABSTRACT

For the reproducible fixing and alignment of an additional part in a robot member, the invention provides a holding device for holding such an additional part on the robot and which has locking elements.

### FIELD OF THE INVENTION

The invention relates to a holding device, particularly for holding additional parts, such as cables, hoses, etc. on a robot member.

### BACKGROUND OF THE INVENTION

DE 299 02 947 U1 discloses such a holding device, in which a multipart ring member is placed around a robot member, such as the flange of a robot hand and is braced against the same. If for any reason it is necessary to release the holding device from the robot member, it is difficult to precisely achieve again the preceding alignment and it is at least necessary beforehand to perform precise measurements and then to correspondingly check the alignment on re-application.

If an arm of the holding device extending radially from said ring part is constructed with a circular cross-section and to which a fastening part or block, to which an additional part is fitted, is fixed in frictionally engaging manner by bracing, once again on release or detachment the precise angular orientation of the fastening part and the linear alignment along the arm axis cannot be readily and easily reproduced and instead, prior to detachment and re-fastening, measurements and adjustments are necessary.

The problem of the invention is to so further develop a holding device of the aforementioned type that a once and for all desired fixing and alignment cart be readily reproduced in rapid manner and without complicated measurements.

### SUMMARY OF THE INVENTION

For this the invention provides a holding device having locking elements. The locking elements can be provided between components of the holding device movable relative to one another for the reproducible, relative fixing thereof to one another, but can also be provided on the holding device in such a way that the latter can be reproducibly fixed to the robot part, such as the flange of a robot hand.

According to a preferred development, the device according to the invention is provided in such a way that a ring part engaging round the robot member has first locking elements for cooperating with locking elements on the robot member, the first locking elements being constructed as axially parallel grooves, which cooperate with one or more ribs or lugs on the robot member for locking purposes. On the robot member can be formed one or more ribs or lugs. In a preferred development, the first locking elements are constructed on the inner circumference of the ring part and in this case the ribs or lugs are provided on the outer circumference of the robot member. A reversal is also possible, if on the robot member is provided a ring part of the holding device as a one-sided, overengaging element, e.g. a clip, which is provided in fixed manner and in particular undetachable manner on the robot member and which engages over the ring part. In this case the clip can partly engage with an outer web in the outer grooves.

For the reproducible linear fixing of a fastening element, which carries the additional part on the radially extending arm of the holding device, according to a preferred development a ring part engaging round a robot member comprises two portions, which can be braced against the ring part and in particular on one arm portion along the longitudinal axis thereof are formed second locking elements, which cooperate with looking elements formed on the inside of a fastening part for the additional part. The second locking elements on the arm can be formed by successively arranged ribs extending transversely to the extension direction of the arm and cooperating with one or more grooves on the inner circumference of the fastening part.

For the reproducible angular fixing of the fastening part on the arm of the holding device, according to a further development third locking elements uniformly distributed over the circumference of the rod and the inner circumference of the fastening part are provided and in particular the third locking elements are formed by the construction of the cross-section of the outer contour of the arm and the inner contour of the fastening part with a finite multiple-fold rotational symmetry. The multiple-fold rotational symmetry of the inner contour of the fastening part is the same as that of the outer contour of the arm or is a multiple thereof. Multiple-fold rotational symmetry designates the angular rotational possibility of a part about an axis, in which a body is transferred into itself and its positions are undistinguishable. A circular part has infinite multiple-fold rotational symmetry and is consequently excluded from the present invention. A square or a four-arm star have a four-fold rotational symmetry, a hexagon a six-fold rotational symmetry, etc. Thus, according to preferred developments of the invention the rod is square and in this case the inner contour of the fastening part is constructed radially with a multple-fold rotational symmetry.

### BRIEF DESCRIPTION OF THE DRAWINGS

Further advantages and features of the invention can be gathered from the claims and the following description of an embodiment of the invention, with reference to the attached drawings, wherein show:

FIG. 1A side view of a holding device according to the invention on a sectionally represented robot member, such as a hand flange.

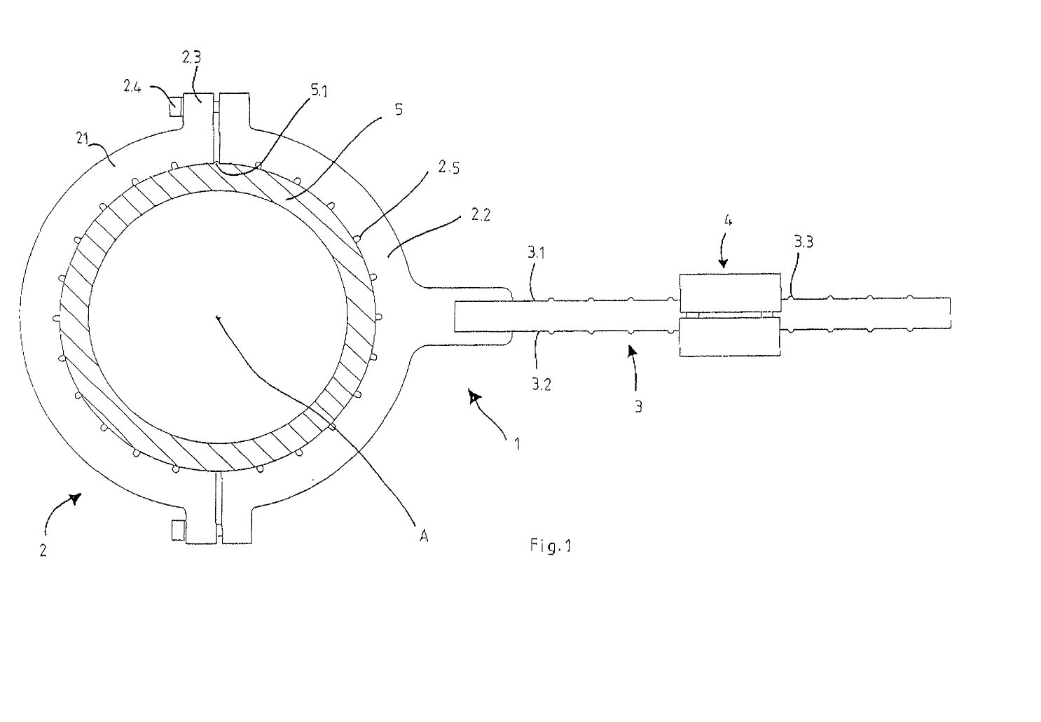

FIG. 2A perpsective view of the holding device according to the invention.

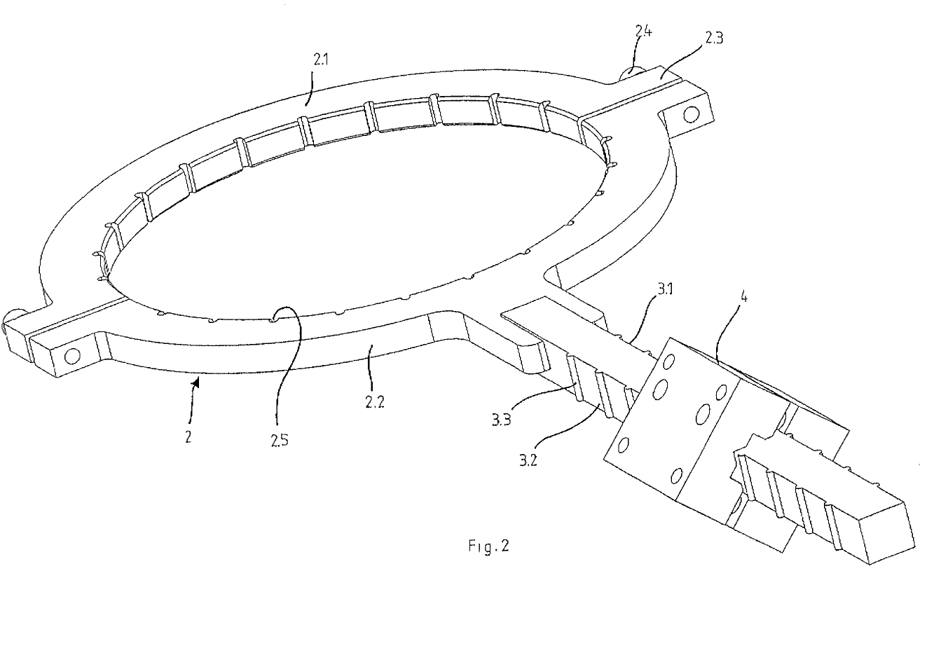

FIG. 3A fastening part corresponding to FIGS. 1 and 2 for fastening an additional part to the robot in perspective view onto the inner contour.

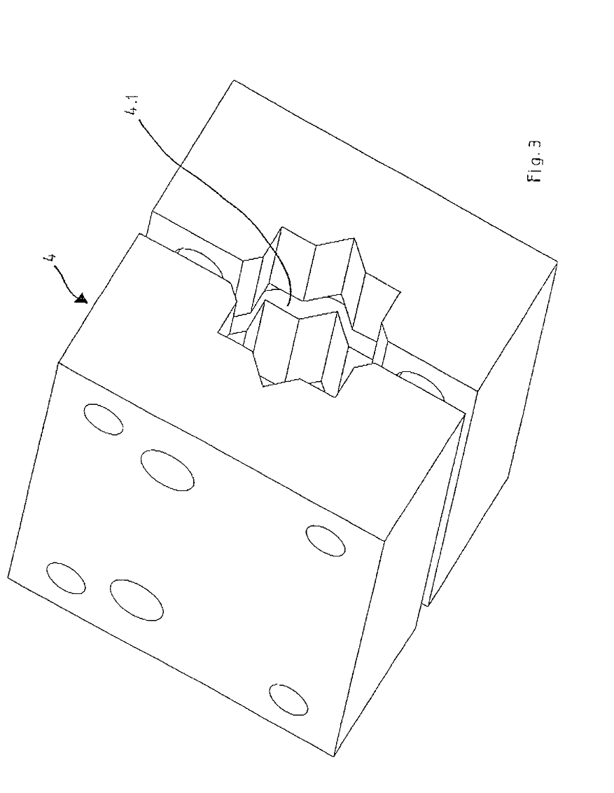

### DETAILED DESCRIPTION OF THE DRAWINGS

The holding device 1 according to the invention has, in the embodiment shown, a ring part 2, an arm 3, a fastening element 4 for fastening additional parts such as cables, hoses, etc. in a robot member.

The holding device 1 according to the invention is fastened by means of the ring part 2 around the robot member 5, such as a hand flange of a robot hand. The ring part 2 has two half-rings 2.1, 2.2, which in each case have shoulders 2.3 by means of which the half-rings 2.1, 2.2 can be firmly connected by screws 2.4 to the complete ring part 2.

The half-rings 2.1, 2.2 are applied to both sides of the robot member 5 and then interconnected by the screws 2.4 and are consequently firmly fastened to the robot member 5.

For the reliable reproducibility of a once chosen, specific angular fixing of the ring part 2 to the robot member 5 and therefore for the fixed alignment of the arm 3, on its inner circumference the ring part 2 has grooves 2.5 axially parallel to its longitudinal axis A (and therefore also to the longitudinal axis of the robot member 5) and which are uniformly distributed over the inner circumference of the robot member 5. These grooves 2.5 can cooperate with lug 5.1 or the rib formed on the outer circumference of the robot member 5. The multiple-fold rotational symmetry of the angular fixing of the ring part or the alignment of the arm 3 results from the number of grooves 2.5.

On its outer circumference and at least on diagonally facing longitudinal faces 3.1, 3.2, the arm 3 has as second locking elements equidistantly spaced along said arm ribs 3.3 for reproducible, linear fixing of the fastening part 4 along the extension direction of the arm 3. A groove 4.1 formed on the inner circumference of the fastening part 4 cooperates as the locking element with the ribs 3.3.

According to the invention there are also third locking elements on the arm 3 and on the fastening part 4 for the reproducible, angular fixing of the fastening part 4 to the arm 3 and which are generally constructed in such a way that the arm 3 is not in the form of a cylinder rod or with a circular cross-section and instead its outer contour, like the inner contour of the fastening part 4, has a finite multiple-fold rotational symmetry, in which the multiple-fold rotational symmetry of the inner contour of the fastening part 4 is equal to or a multiple of that of the outer contour of the arm 3. In the represented embodiment the arm 3 is parallelepipedic, i.e. it has a square cross-section with four edges and four angles and therefore a four-fold rotational symmetry, whereas the inner contour of the fastening part 4 has the cross-section of a star with eight arms, i.e. an eight-fold rotational symmetry and which in the represented embodiment is twice that of the multiple-fold rotational symmetry of the circumferential contour of the arm 3.

The arms of the star inner contour of the fastening part 4 have in the represented embodiment an interior right angle, corresponding to the exterior right angle of the edges of the arm 3. In principle, the star-like or radical notches or grooves determining the multiple-fold rotational symmetry of the fastening part 4 should have an interior angle corresponding to the angle of the edges of the outer contour of the arm 3. In the case of a triangular rod (three-fold rotational symmetry) with inner edge angles of 60°, the inner contour of the fastening part 4 should have a six, nine, twelve-arm star (six, nine or twelve-fold rotational symmetry) and the interior angle of the arms determining the inner contour of the fastening part 4 should also be 60°. With a five-fold arm 3, i.e. with five edges, in which the lateral faces form an angle of 108°, the inner contour of the fastening part should be four, five, ten, fifteen-fold, the interior angle of the arms forming said contour also being 108°. The same applies with arms 3 formed for six or more edges.

This also makes it possible to simply and reproducibly obtain a once provided, desired, angular alignment of the fastening part 4 and therefore the additional part to be fixed thereto about the arm 3.

### LIST OF REFERENCE NUMERALS

1 Fastening device

2 Ring part

2.1, 2.2 Half-rings

2.3 Shoulders

2.4 Screws

2.5 Axially parallel grooves

3 Arm

3.1, 3.2 Longitudinal faces

3.3 Ribs

4 Fastening element

4.1 Groove

5 Robot member

5.1 Lug

8 Multiple-fold rotational symmetry

1. Holding device, particularly for holding additional parts, such as cables, hoses, etc. an a robot member, characterized by locking elements.

2. Holding device according to claim 1, characterized in that a ring part engaging round the robot member has first locking elements for cooperating with locking elements on the robot member.

3. Holding device according to claim 1, characterized in that the first locking elements are constructed as axially parallel grooves, which cooperate with one or more ribs or lugs on the robot member for locking purposes.

4. Device according to claim 1, characterized in that the first locking elements are constructed on the inner circumference of the ring part.

5. Device according to claim 1, characterized in that a ring part engaging round a robot member comprises two portions, which can be braced against the ring part.

6. Device according to claim 1, characterized in that on an arm portion are formed second locking elements along its longitudinal direction and which cooperate with locking elements formed on the inside of a fastening part for the additional part.

7. Device according to claim 6, characterized in that the second locking elements are formed on the arm by ribs arranged successively along the same and extending transversely to the arm extension direction and which cooperate with one or more grooves on the inner circumference of the fastening part.

8. Device according to claim 1, characterized by third locking elements uniformly distributed over the circumference of the rod and the inner circumference of the fastening part.

9. Device according to claim 8, characterized in that the third locking elements are formed by having the cross-section of the outer contour of the arm and the inner contour of the fastening part with finite multiple-fold rotational symmetry, in which the multiple-fold rotational symmetry of the inner contour of the fastening part is the same or a multiple of that of the outer contour of the arm.

10. Device according to claim 9, characterized in that the rod is square (four-fold rotational symmetry).

11. Device according to claim 10, characterized in that the inner contour of the fastening part is constructed radially with an eight-fold rotational symmetry.

12. Device according to claim 1, characterized in that the notches or grooves of a fastening part surrounding another part have internal angles corresponding to the angles of the edges of the other part.
